(19) United States
(12) Patent Application Publication
(10) Pub. No.: US 2005/0016229 A1
(43) Pub. Date: Jan. 27, 2005

(54) Hasp lock

(76) Inventor: David J Evans, Dee Why (AU)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/493,404

(22) PCT Filed: Oct. 22, 2002
(86) PCT No.: PCT/AU02/01433

(30) Foreign Application Priority Data
Oct. 23, 2001 (AU) PR8430

(51) Int. Cl. E05B 65/48

(52) U.S. Cl. 70/9

(57) ABSTRACT

A hasp lock has a casing to be mounted on a door and pivotally mounted to be displaceable between a first position, in which the casing overlies a securing structure mounted on a door frame with a cylinder lock operable to lock the casing to the securing structure, and a second position to which the casing can be pivotally moved when the cylinder lock has been unlocked so that the door may be freely opened and closed.

### FIELD OF THE INVENTION

The present invention relates to hasp locks.

### BACKGROUND TO THE INVENTION

Hasp locks are required in installations such as security locks for a door, a pair of doors, gates, enclosures with lids, etc., having respective frame elements closely adjacent to one another in the closed position. The hasp unit has a mounting plate which permits it to be fixed to one of the door frames and a pivotal cover plate is thereby mounted to swing over to cover fixing screws. Usually, a free end portion is engaged with a staple unit. The staple unit has its own mounting plate which is fixed to the second door frame and fixing screws are covered by the cover plate in the closed position. The staple typically protrudes through a slot in the cover plate thereby facilitating installation of a padlock.

While a reasonably secure installation can be provided, there is the problem, when the door is opened, of the freely pivotal cover plate and the general unsightliness and clumsiness of a padlock. While this may be acceptable in an industrial application, for many applications such as shops, domestic and general commercial installations there has not been made available a design which lends itself to permitting a highly secure lock to be formed yet one which, when unlocked, can provide an elegant appearance.

Furthermore many padlocks have a locking element which can often be exposed to cutting implements and therefore security is questionable.

### SUMMARY OF THE INVENTION

The present invention proposes new and useful alternatives to previous proposals and which are aimed at providing a cylinder locking solution to hasp type locks.

In one aspect the present invention provides a lock for mounting between first and second substrates associated with structures which are adjacent when in the locking position, the lock having:
a) a mounting structure for attachment to the first substrate;
b) a body structure pivotally mounted on the mounting structure for rotation relative to the first substrate between securing and free positions;
c) a securing structure adapted to be mounted on the second substrate and to co-operate with the-body structure when in the securing position;
d) a cylinder lock being adapted to have an exposed access for a key and being adapted to be mounted on either the body structure or the securing structure, the other of the body structure and the securing structure having a cavity providing a locking shoulder for receiving a laterally displaceable locking element of the cylinder lock when the locking structure is in the securing position and the lock is locked.

In a preferred embodiment, the mounting structure and securing structure are respectively adapted to be mounted on the substrates with screws, the heads of which are covered by the body structure when in the securing position.

One embodiment consists in providing the body structure with a casing having a peripheral skirt adapted to lie adjacent to the first and second substrates in the securing position and the cylinder lock is accommodated either by being mounted on the fixing structure and having its outer portion projecting through a corresponding aperture in the body structure, with the cylinder lock actuating a laterally displaceable element to engage a latching shoulder in the cavity of the body structure; an alternative embodiment is the reverse where the body structure permanently mounts the cylinder lock and the fixing structure includes a cavity structure with a locking shoulder for inter-engaging with a laterally displaceable element of the cylinder lock when in the securing position.

Preferably the mounting structure permits relative pivotal motion about a horizontal axis so that the body structure can pivot from its normal horizontally projecting direction to a vertically directed direction so as to hang down when opened.

A further embodiment facilitates the mounting structure mounting on a surface at 90 degrees to the front surface of the first substrate over which the body structure has to extend by a multiple joint pivotal arm mount.

### BRIEF DESCRIPTION OF THE DRAWINGS

The invention will be further described with reference to the accompanying drawings which illustrate embodiments of the invention. In the drawings:

FIG. 1 is the front elevation of the first embodiment in the securing or locked position;

FIG. 2 is a side elevation of the first embodiment;

FIG. 3 is an inverted plan view of the first embodiment;

FIG. 4 is a sectional side elevation along the line (IV)-(IV) of FIG. 1;

FIG. 5 is a cross sectional inverted plan view along the line (V)-(V) of FIG. 1;

FIG. 6 is an exploded view of the components of the first embodiment;

FIG. 7 is an isometric view showing the first embodiment mounted to respective door frames in the locked position;

FIG. 8 is a rear view of the first embodiment in the locked position;

FIG. 9 is an isometric view corresponding to FIG. 7 but in the unlocked position;

FIG. 10 is a view corresponding to FIG. 8 showing the rear of the lock in the unlocked position;

FIG. 11 is an isometric view of a second embodiment in the closed position;

FIG. 12 is a view corresponding to FIG. 11 showing the structure when mounted in a closed position in a different configuration;

FIG. 13 is a view of the third embodiment with a double knuckle mounting plate arrangement for alternative installations;

FIG. 14 is a front view of a fourth embodiment having similarity to the first embodiment but accommodating the cylinder lock in the outer casing;

FIG. 15 is an inverted plan view of the fourth embodiment;

FIG. 16 is a sectional side elevation taken along the line A-A of FIG. 14;

FIG. 17 is a cross sectional plan view taken along the line C-C of FIG. 14;

FIG. 18 is an exploded view of the parts of the fourth embodiment;

FIG. 19 is an isometric view in the closed position illustrating the fourth embodiment when attached to door frames; and

FIG. 20 is a view of the embodiment of FIG. 19 when in an open position.

### DETAILED DESCRIPTION OF THE DRAWING

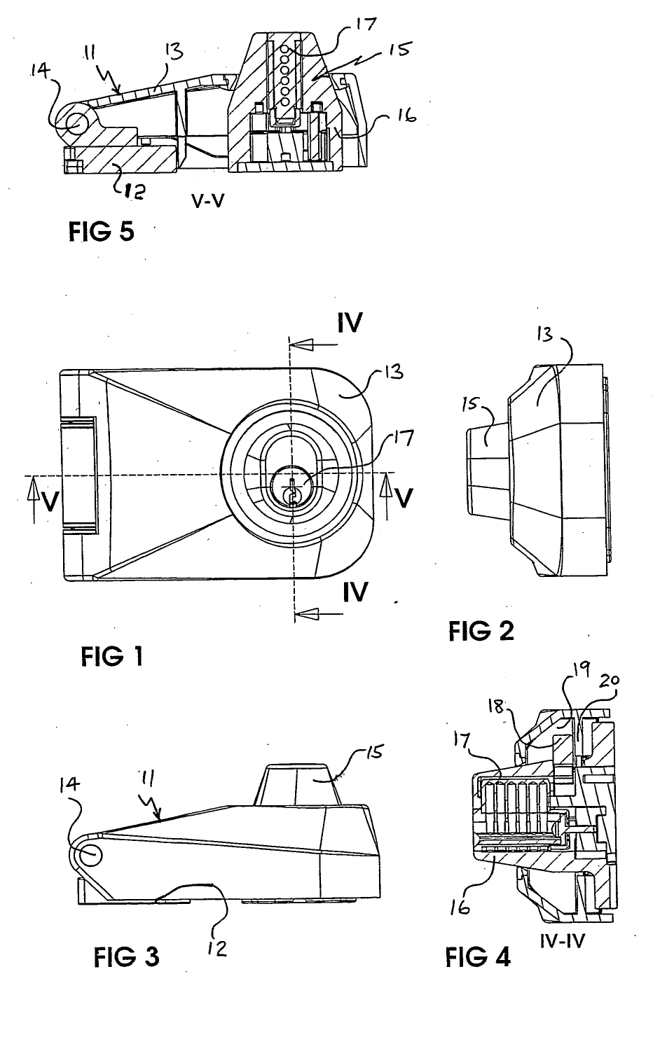

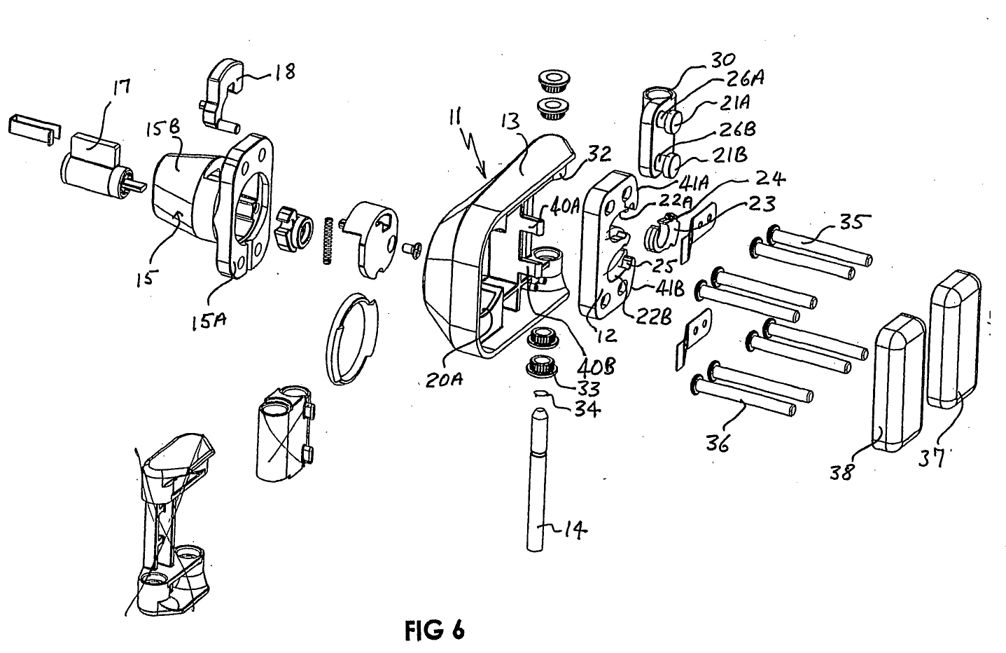

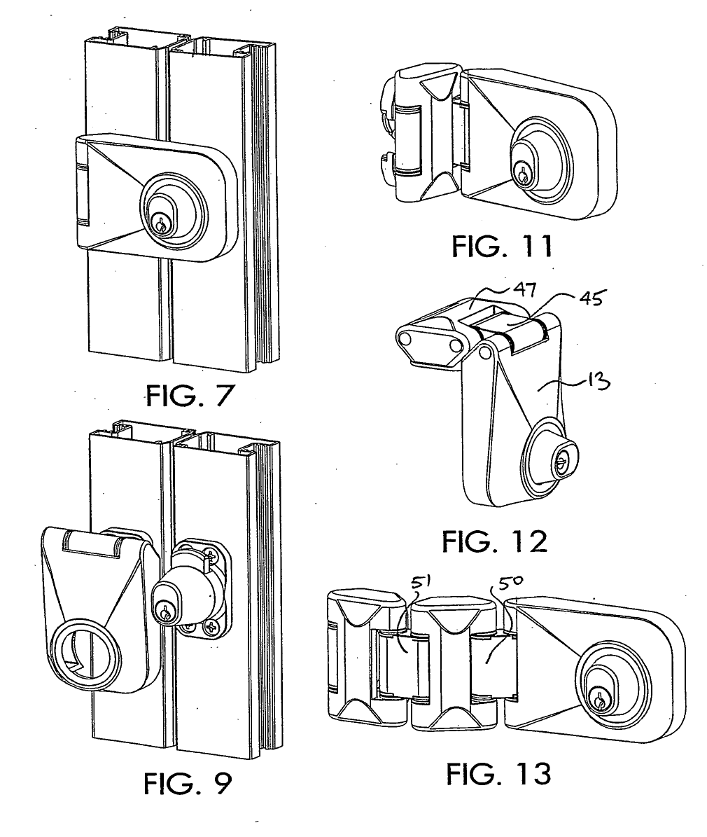

Referring first to FIGS. 1-10 of the first embodiment, the product comprises a hasp unit 11 principally comprising a mounting plate 12 and an outer casing 13 mounted by hinge pin 14 on the mounting plate 12, and a locking unit 15 having a tapered barrel shape body 16 mounting a cylinder lock 17. The lock actuates a locking arm 18, shown clearly for example in FIG. 4 and which, in the locked position, engages into a cavity 19 for abutment against a locking shoulder 20 associated with the casing 13.

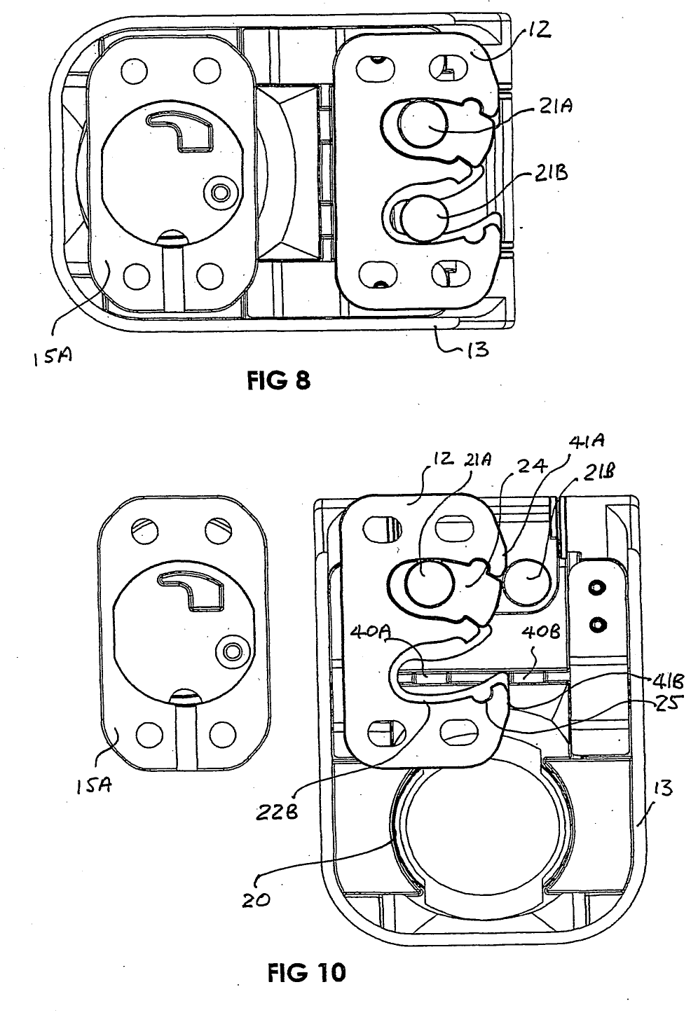

FIG. 6 shows in more detail the components. Of particular significance and shown in FIG. 6 is a symmetric structure to permit the lock to be mounted in either a left hand or right hand configuration. Thus, when the lock is chosen to be installed with the locking arm 18 uppermost, then it engages behind the locking shoulder 20 having a lip 20A. The casing is in the configuration shown in FIG. 6, ie a left hand hinge. When the casing is inverted for a right hand hinge, then the locking shoulder 20A shown in FIG. 6 becomes uppermost as there is a symmetric arrangement in the casing. Similarly, the mounting plate 12 has mirror image arcuate apertures 22A and 22B, either of which can accommodate an insert or retainer 23 which fits laterally into one of the apertures, a retaining rib 24 engaging in a corresponding groove 25 whereby a circular passageway in the retainer extends around the associated head of a pivot pin 21A or 21B. The pivot pins have respective reduced diameter necks 26A and 26B which engage in the narrow portion of the base of the arcuate slots. From the configuration shown in FIG. 6, the pivot pins 21A and 21B are engaged laterally into their respective arcuate slots, and then the retainer 24 inserted into the upper slot shown in FIG. 6 to retain the upper pivot pin 21A relative to the mounting plate but about which the mounting plate can pivot. The lower pin 21B is not so constrained and as the mounting plates and with it the hasp unit 11 rotates about the horizontal axis of pin 21A, the position shown in FIG. 10 can become adopted.

Hinging is provided by a hinge barrel 30 to which the mounting plate 12 is attached, the barrel being aligned with circular cross section guides 31 and 32 formed in the casing and the hinge pin 14 is then inserted using suitable plastic bearings 33 and the pin retained by a circlip 34.

FIG. 6 shows a set of form screws 35 for securing the mounting plate 12 to the frame, eg of a sliding door and a set of screws 36 similarly for fixing a base plate 15A of the locking unit 15. Respective cover plates 37 and 38 are provided for the exposed ends of the screws.

Usually the casing pivots about a vertical axis defined by the main hinge pin 14 but when moved to the open position (see FIGS. 9 and 10) the lower pin 21B can move accurately along its mounting slot so that the hinge axis is now horizontal and the casing can pivot downwardly to the open position where it rests under gravity. In this position it is positively restrained from rotation around pin 21A by inter-engagement of a tab 40B formed on the rear of the casing with a leading face 41B of the mounting plate 12. The casing has a symmetrically disposed second tab 40A and the mounting plate has a second leading edge 41A so when reassembled for a right hand hinge, these components inter-engage to restrain rotation when in the fully open position and the lock is hanging down as illustrated particularly in FIGS. 9 and 10.

The preferred embodiment uses a cylinder lock which is such that the key cannot be withdrawn in the open position but first must be moved again to the locked position.

This is an important security feature as it prevents accidental locking.

The drawings show an attractively shaped product with the tapering oval shaped barrel 15B of the locking unit which fits into close engagement with a corresponding aperture in the casing.

FIGS. 11 and 12 show an alternative embodiment in which an extra hinging element is provided for mounting the base plate to suit certain installations where mounting must be to a face of a substrate extending at an angle such as 90 degrees to the face over which the lock operates. A knuckle joint 45 connects the casing 13 to a mounting or base unit 46 having a base plate 47 corresponding to the mounting plate 12 of the first embodiment. FIG. 13 shows a more complex unit with two pivotal links to suit more complex installations. This embodiment uses two knuckle joints 50 and 51.

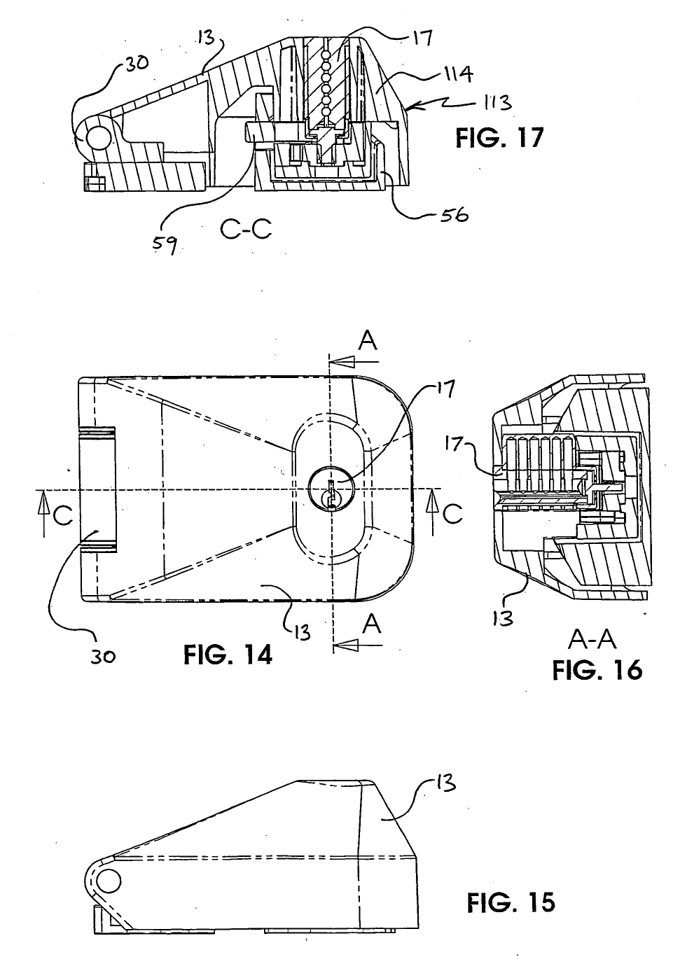

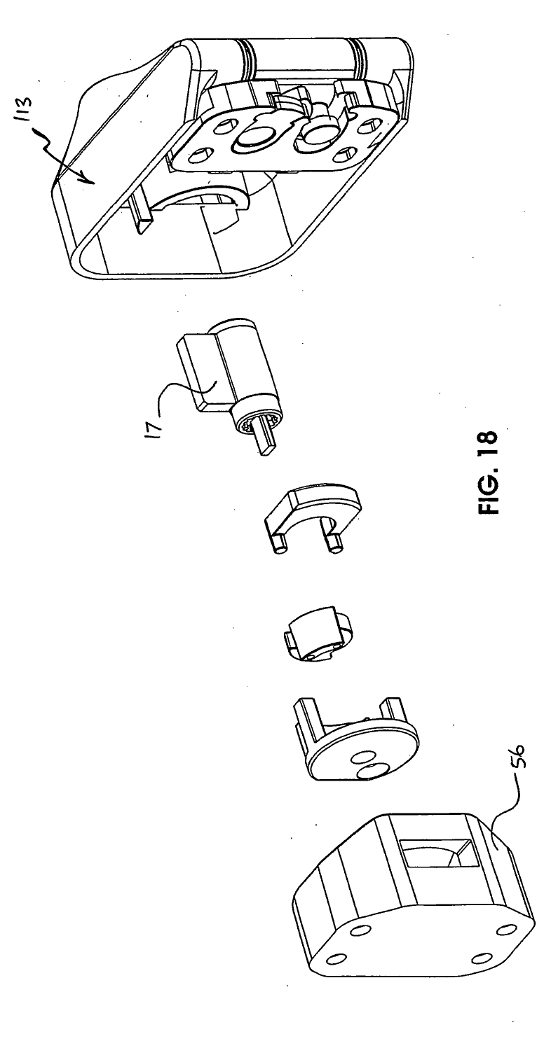

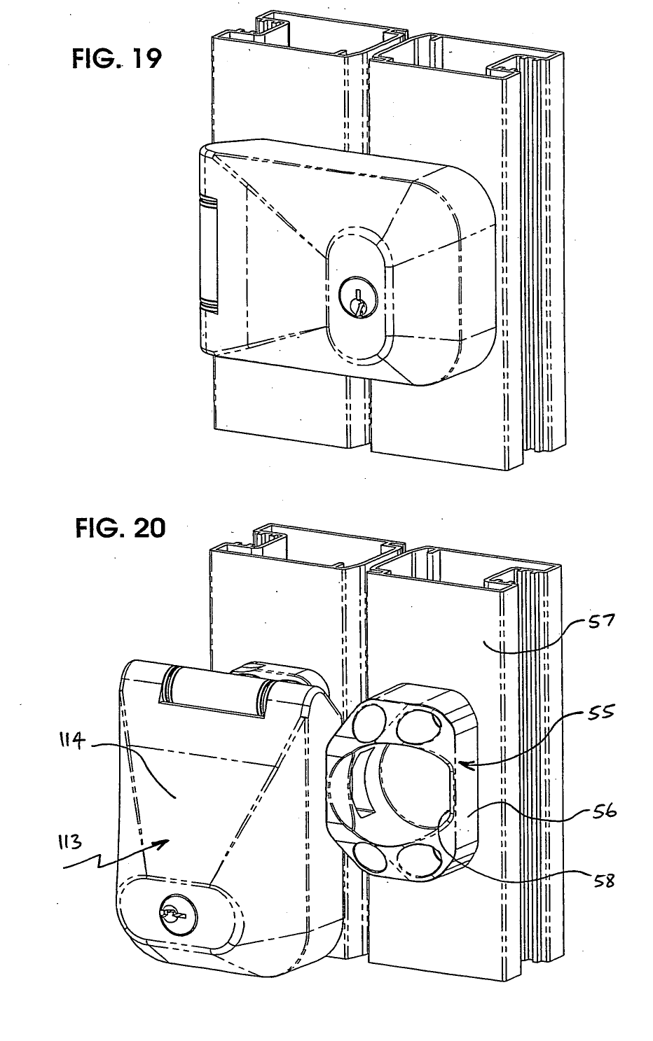

Referring now to FIGS. 14-20, the components compared with the first embodiment are similar and like reference numerals have been used for like parts. In this embodiment the casing 113 provides a profiled exterior 114 mounting the cylinder lock 17. The lock engages with a “hasp” in the form of a securing structure 55 (see FIG. 20) which in this case has a generally tubular base plate 56 adapted to be fixed with a series of screws (not shown) to a door frame 57. A cavity 58 is provided with a locking element 59 driven by the cylinder lock 17 being displaced in the locking position as shown in FIG. 17 engaging in the cavity of the base plate and engaging behind a locking shoulder 59.

1. A lock for mounting between first and second substrates associated with structures which are adjacent when in the locking position, the lock having:
a) a mounting structure for attachment to the first substrate;
b) a body structure mounted on the mounting structure and having a locking portion for rotation relative to the first-substrate about a first axis substantially parallel to a plane extending over the first and second substrates for moving the locking portion between a securing position and a retracted position;
c) a securing structure adapted to be mounted on the second substrate and to co-operate with the locking portion of the body structure when in the securing position;
d) a cylinder lock being adapted to have an exposed access for a key and being adapted to be mounted on either the body structure or the securing structure, the other of the body structure and the securing structure having a cavity providing a locking shoulder for receiving a laterally displaceable locking element of the cylinder lock when the locking portion is in the securing position and the cylinder lock is key locked; and
e) the body structure having a pivotal mounting on the mounting structure for pivoting about a second axis extending outwardly from the first substrate so that the locking structure can be located in a rest position adjacent the first substrate and spaced from the securing structure, whereby the first and second substrates may be relatively moved without interference from the body structure.

2. A lock as claimed in claim 1, wherein the first axis and second axis extend substantially at right angles to one another.

3. A lock as claimed in claim 2, and including means for installing the lock with the first axis parallel to a face of the first substrate and the second axis at right angles to the face of the first substrate.

4. A lock as claimed in claim 3, wherein the cylinder lock has an axis at right angles to the face of the first substrate when the lock is in the locked position.

5. A lock as claimed in any one of the preceding claims, wherein the mounting structure and securing structure are adapted to be mounted on the respective substrates with screws, the heads of which are covered by the body structure when in the securing position.

6. A lock as claimed in any one of the preceding claims, wherein the body structure has a casing having a peripheral skirt adapted to lie adjacent to the first and second substrates in the securing position and the cylinder lock is accommodated by being mounted on the fixing structure and having its outer portion projecting through a corresponding aperture in the body structure, the cylinder lock actuating a laterally displaceable element to engage behind a latching shoulder in the cavity of the body structure.

7. A lock as claimed in any one of claims 1-5, wherein the body structure-permanently mounts the cylinder lock and the securing structure includes a cavity structure with a locking shoulder for inter-engaging with a laterally displaceable element of the cylinder lock when in the securing position.

8. A lock as claimed in any one of the preceding claims, wherein the body structure has a generally rectangular form in front elevation viewed along an axis normal to the first substrate, in the securing position a major axis of the body structure extends horizontally, and the pivotal mounting of the body structure permits relative pivotal motion about an axis normal to the first substrate so that the body structure can pivot such that the major axis projects vertically downwardly when the lock is in the free position.
